(19) United States
(12) Patent Application Publication
(10) Pub. No.: US 2010/0289898 A1
(43) Pub. Date: Nov. 18, 2010

(54) Device having a video camera which is built into in a rear-view mirror assembly in a vehicle

(76) Inventor: Bernhard Nixdorf, Stuttgart (DE)

Correspondence Address: KENYON & KENYON LLP, ONE BROADWAY, NEW YORK, NY, 10004, US

(21) Appl. No.: 12/227,372

(22) PCT Filed: May 9, 2007
(86) PCT No.: PCT/EP2007/054477

§ 371 Date: Aug. 10, 2010

(30) Foreign Application Priority Data
Jun. 12, 2006 (DE) 102006027118.1

(51) Int. Cl. H04N 7/18

(52) U.S. Cl. 348/148; 348/E07.085

(57) ABSTRACT

In a device having a video camera oriented in the direction of travel and built into a rear-view mirror assembly of a vehicle, provision is made that a rearward-directed light sensor is additionally provided in the rear-view mirror assembly; and that a device for reducing the reflectivity of the rear-view mirror is controllable by the signals of the video camera and of the light sensor.

### FIELD OF THE INVENTION

The present invention relates to a device having a video camera oriented in the direction of travel and built into a rear-view mirror assembly of a vehicle.

### BACKGROUND INFORMATION

Video cameras oriented substantially in the direction of travel are used, usually in combination with image processing devices, for a variety of purposes, for example for lane departure warning (LDW), for night vision, and to detect and display obstacles. Systems of this kind are also called driver assistance systems. A video camera oriented forward and built into a rear-view mirror assembly is described, for example, in German Patent Application No. DE 100 19 304 A1.

In order to prevent dazzling by the headlights of following vehicles, the reflectivity of the rear-view mirror is automatically reduced (i.e., dimmed). A device provided therefor has been described, for example, in U.S. Pat. No. 6,742,904 B2. Here the ambient brightness is determined using a light sensor directed forward, and the intensity of the light incident onto the inside mirror from behind is monitored by a light sensor directed rearward. A reduction in the reflectivity of the rear-view mirror is performed when the forward-directed light sensor indicates low light, and the rearward-directed light sensor indicates bright incident light.

### SUMMARY

According to an example embodiment of the present invention, a rearward-directed light sensor is additionally provided in the rear-view mirror assembly, and a device for reducing the reflectivity of the rear-view mirror is controllable by the signals of the video camera and of the light sensor. Provision is preferably made in this context that the video camera is connected to an image processing device.

The example device according to the present invention has the advantage of a cost reduction because of the combined use of the video camera for the respective video system (driver assistance system) and for the rear-view mirror. The device according to the present invention additionally has the advantage that overall size is reduced as compared with two systems, namely the automatically dimmable rear-view mirror and a driver assistance system.

In a refinement of the present invention, this advantage is achieved in particular in that the image processing device is likewise disposed in the rear-view mirror assembly.

Further savings may be achieved by the fact that the video camera, the light sensor, the image processing device, and the control device are disposed on a circuit board.

An advantageous example embodiment of the device according to the present invention consists in the fact that a microcontroller evaluates the output signals of the video camera and of the light sensor, and generates control signals for controlling the reflectivity of the rear-view mirror.

With this example embodiment, unlike with the forward-directed light sensor, more-detailed evaluation capabilities are possible for dimming the inside mirror, by way of two-dimensionally resolved brightness distribution in the region in front of the vehicle.

Another advantageous example embodiment consists in the fact that the microcontroller further contains a program for a driver assistance function, and a terminal for a human-machine interface is provided. The human-machine interface, for example an LCD display and operating elements, can be disposed at an ergonomically advantageous location in the vehicle.

### BRIEF DESCRIPTION OF THE DRAWINGS

Exemplary embodiments of the present invention are depicted in the figures, and explained further in the description below.

FIG. 1 is a block diagram of an example device according to the present invention.

FIG. 2 schematically depicts the example device according to the present invention built into a vehicle.

FIG. 3 shows two views of a circuit board having the video camera and the light sensor.

### DETAILED DESCRIPTION OF EXAMPLE EMBODIMENTS

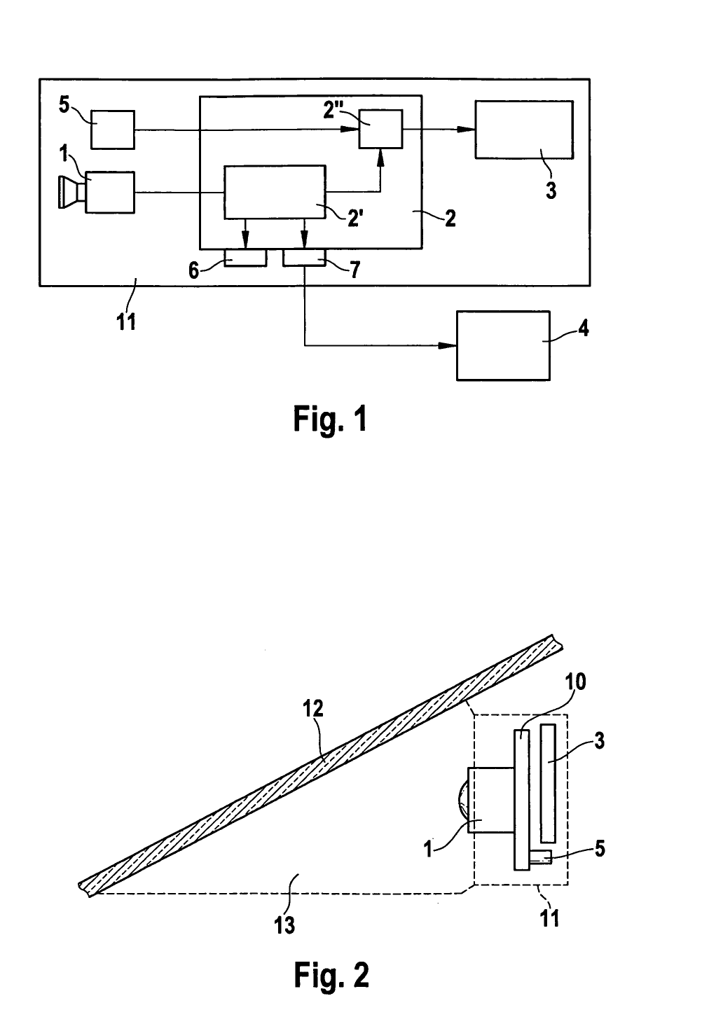

FIG. 1 shows a video camera 1 (hereinafter also called a video sensor), an evaluation unit 2, a rear-view mirror 3 (preferably an inside mirror) with controllable reflectivity, and a human-machine interface (HMI) 4. Rear-view mirrors with controllable reflectivity are known per se and are described, for example, in U.S. Pat. No. 6,742,904 B2. An electrochromic layer, through which a controllable current flows, is often applied onto the mirror In order to control the reflectivity; the greater the current, the lower the reflectivity.

Also connected to evaluation unit 2 is a rearward-directed light sensor 5. Except for the human-machine interface, the aforesaid elements are built into a housing 11 of rear-view mirror 3.

Evaluation unit 2 may be constituted substantially by a microcontroller that, by way of corresponding programs, represents a video-based driver assistance system 2′. The microcontroller furthermore constitutes a control device 2″ for rear-view mirror 3. A vehicle bus (not further depicted) and human-machine interface 4 are connectable via terminals 6, 7.

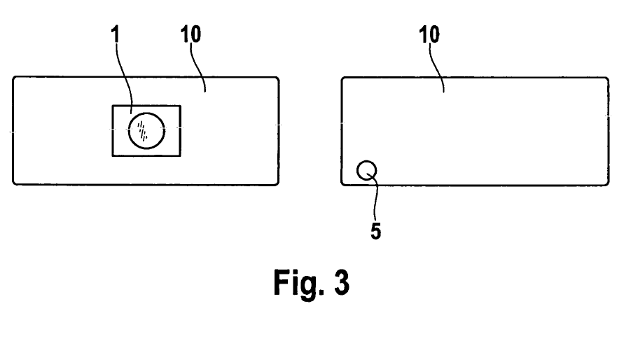

FIG. 2 schematically shows a circuit board 10 having light sensor 5 and video sensor 1, which are disposed in mirror housing 11 together with rear-view mirror 3. Video sensor 1 acquires an image of the area in front of the vehicle through a windshield 12. A glare baffle 13 is provided in order to prevent glare. Circuit board 10, further depicted in FIG. 3, carries on one side light sensor 3 and on the other side video sensor 1 looking in the direction of travel.

1-6. (canceled)

7. A device, comprising:
a video camera oriented in a direction of travel of a vehicle and built into a rear-view mirror assembly of the vehicle;
a rearward-directed light sensor situated in the rear-view mirror assembly; and
a control device adapted to reduce reflectivity of the rear-view mirror, the control device being controllable by signals of the video camera and the light sensor.

8. The device as recited in claim 7, wherein the video camera is connected to an image processing device.

9. The device as recited in claim 8, wherein the image processing device is disposed in the rear-view mirror assembly.

10. The device as recited in claim 8, wherein at least one of the video camera, the light sensor, the image processing device, and the control device are disposed on a circuit board.

11. The device as recited in claim 7, further comprising:
a microcontroller adapted to evaluate output signals of the video camera and the light sensor, and generate control signals for controlling the reflectivity of the rear-view mirror.

12. The device as recited in claim 11, wherein the microcontroller further includes a program for a driver assistance function, and the device further includes a terminal for a human-machine interface.
